(19) United States
(12) Patent Application Publication
(10) Pub. No.: US 2015/0226170 A1
(43) Pub. Date: Aug. 13, 2015

(54) Pressure Regulator Damping

(71) Applicant: Woodward, Inc., Fort Collins, CO (US)

(72) Inventors: Brett J. Snodgrass, Byron, IL (US); Paul J. Schaefer, Rockton, IL (US)

(73) Assignee: Woodward, Inc., Fort Collins, CO (US)

(21) Appl. No.: 14/178,546

(22) Filed: Feb. 12, 2014

(51) Int. Cl. F02M 69/54

(52) U.S. Cl. CPC F02M 69/54

(57) ABSTRACT

The subject matter of this specification can be embodied in, among other things, a fuel pressure regulator system for regulating pressure through a fuel delivery path that includes a fuel pressure regulator valve in the fuel delivery path operable to selectively provide a restriction in the fuel delivery path in response to a reference fluid pressure, a reference fluid path comprising a first orifice, a second orifice and an outlet downstream of the first orifice, the reference fluid path coupled to the fuel pressure regulator valve intermediate the first and second orifices to supply the reference fluid pressure to the fuel pressure regulator valve, and a reference fluid valve upstream of the first orifice operable to selectively provide a restriction into the reference fluid path.

### TECHNICAL FIELD

The concepts herein relate to fluid pressure regulators and more particularly to fluid pressure regulators with damped regulation responses.

### BACKGROUND

Pressure regulators can maintain the pressure of fluid provided at the inlet of the pressure regulator above the pressure of a reference fluid. The reference fluid is also provided to the regulator. The upstream fluid can then be provided at the higher, regulated, pressure to other valves and equipment.

Many pressure regulators use a loading element such as a spring to apply a force to a restricting element that limits the available flow area through the pressure regulator. The spring and restricting element combination gives a spring-mass system that can oscillate under varying combinations of upstream fluid pressure, downstream fluid pressure, and reference pressure inputs.

### SUMMARY

In general, this document describes fluid pressure regulators.

In a first aspect, a fuel pressure regulator system for regulating pressure through a fuel delivery path includes a fuel pressure regulator valve in the fuel delivery path operable to selectively provide a restriction in the fuel delivery path in response to a reference fluid pressure, a reference fluid path comprising a first orifice, a second orifice and an outlet downstream of the first orifice, the reference fluid path coupled to the fuel pressure regulator valve intermediate the first and second orifices to supply the reference fluid pressure to the fuel pressure regulator valve, and a reference fluid valve upstream of the first orifice operable to selectively provide a restriction into the reference fluid path.

Various implementations can include all, some, or none of the following features. The reference fluid valve can be operable in response to a control signal. The control signal can be indicative of a threshold speed of an engine, and the reference fluid valve can be operable to provide the restriction into the reference fluid path when the control signal indicates that the engine is operating below the threshold speed and remove the restriction into the reference fluid path when the control signal indicates that the engine is operating at or above the threshold speed. The reference fluid valve can be operable in response to the reference fluid pressure, the reference fluid valve providing the restriction into the reference fluid path when the reference fluid pressure is below a threshold pressure and removing the restriction into the reference fluid path when the reference fluid pressure is at or above the threshold pressure. The reference fluid pressure can be indicative of an operating speed of an engine, and the threshold pressure can be reflective of the threshold operating speed of the engine.

In a second aspect, a method for regulating fuel pressure through a fuel delivery path includes providing a fuel pressure regulator valve in the fuel delivery path operable to selectively provide a restriction between a fuel inlet and a fuel outlet in the fuel delivery path in response to a reference fluid pressure, providing a reference fluid path comprising a first orifice, a second orifice and an outlet downstream of the first orifice, the reference fluid path coupled to the fuel pressure regulator valve intermediate the first and second orifices to supply the reference fluid pressure to the fuel pressure regulator valve. The method also includes providing a reference fluid valve upstream of the first orifice operable to selectively provide a restriction into the reference fluid path/providing a reference fluid at the reference fluid valve, providing a first control signal at the reference fluid valve, restricting by the reference fluid valve in response to the first control signal flow of the reference fluid, providing the reference fluid and a second control signal at the reference fluid valve, flowing, by the reference fluid valve in response to the second control signal, the reference fluid to the first orifice, restricting by the first orifice flow of the reference fluid to the reference fluid path, restricting by the second orifice flow of the reference fluid out of the reference fluid path wherein flow of the reference fluid into the reference fluid path and flow of the reference fluid out of the reference fluid path create the reference fluid pressure as a differential pressure in the reference fluid path, providing fuel to the fuel pressure regulator valve at the fuel inlet, and selectively providing, by the fuel pressure regulator valve and in proportion to the reference fluid pressure, the restriction between the fuel inlet and the fuel outlet in the fuel delivery path in response to the reference fluid pressure.

Various implementations can include some, all, or none of the following features. The first control signal can be indicative of an engine running below a threshold speed, and the second control signal can be indicative of the engine running at or above a threshold speed. The first control signal can be a first pressure of the reference fluid, and the second control signal can be a second pressure of the reference fluid. At least one of the first control signal and the second control signal can be an electrical command from the engine.

The systems and techniques described here may provide one or more of the following advantages. First, a system can provide damping of the pressure regulator that is independent of amplitude by using a flowing orifice damping arrangement. Second, the system can provide two different reference pressure levels by turning off the flowing orifice damping arrangement. Third, the system can reduce the size and/or weight of a fluid pump used to supply a reference and inlet fluid to the system.

The details of one or more implementations are set forth in the accompanying drawings and the description below. Other features and advantages will be apparent from the description and drawings, and from the claims.

### DESCRIPTION OF DRAWINGS

FIGS. 1 and 2 are schematic diagrams of fluid pressure regulators with orifice damping.

FIG. 3 is a schematic diagram of an example fluid pressure regulator that implements orifice damping with switching.

FIGS. 4 and 5 are schematic diagrams of an example fluid delivery system that includes an example fluid pressure regulator with damping.

### DETAILED DESCRIPTION

This document describes systems and techniques for regulating fluid pressure with a damped response. Pressure regulators generally use a loading element such as a spring to apply a force to a restricting element that limits the area available for flow of fluid through the pressure regulator. The regulated pressure is set by a reference pressure input that is additive to the force applied by the loading element. The loading and restricting elements, however, can oscillate under varying combinations of upstream fluid pressures, downstream fluid pressures, and reference pressure inputs. Two damping schemes used for pressure regulator systems include laminar damping and orifice damping. Laminar damping is proportional to valve velocity, but can be sensitive to temperature when the viscosity of the fluid being regulated is highly temperature dependent. Due to this temperature sensitivity, laminar damping is not typically implemented on pressure regulators that must operate over a wide temperature range.

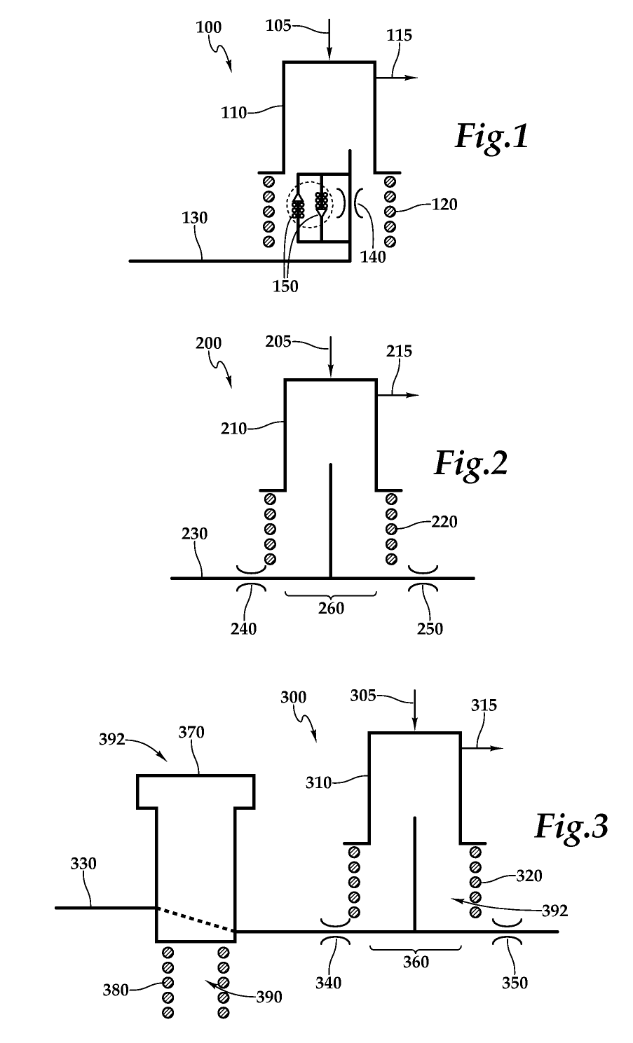

FIG. 1 is schematic diagram of a fluid pressure regulator 100 that uses non-flowing orifice damping. A fluid with a pressure to be regulated is provided at an input 105 of a valve 110. A spring 120 urges the valve 110 toward a position that restricts or blocks fluid flow between the inlet 105 and the outlet 115.

A control fluid is provided as a reference pressure at an input 130. In general, as flow at the inlet 105 decreases the reference pressure 130 is added to the bias force of the spring 120 to urge the valve 110 toward a position that restricts fluid flow between the inlet 105 and the outlet 115. Reducing the allowable flow area as flow level decreases maintains the inlet 105 pressure level. Likewise, the valve 110 moves toward a less restrictive position as flow level increases. Overall, the inlet 105 pressure level remains at approximately a fixed amount above the reference 130 pressure level regardless of the amount of flow through the valve.

The valve 110 and spring 120 combination gives a spring-mass system that is prone to being unstable without damping. The pressure regulator 100 includes a non-flowing orifice 140 that provides damping by restricting the flow of control fluid in and out of the valve 110.

Non-flowing orifice damping, as implemented by the pressure regulator 100, is substantially temperature insensitive (e.g., good), but is proportional to the square of valve velocity (e.g., bad). As a result, the non-flowing orifice 140 provides little or no damping when the valve 110 is stationary, and overdamps the valve 110 during large disturbances (e.g., when flow through the valve rapidly changes). To offset the over-damping problem, a collection of check valves 150 are positioned in parallel with the non-flowing orifice 140. The check valves 150 shunt the orifice 140 during large, fast transients exhibited at the valve 110.

FIG. 2 is schematic diagram of a prior art fluid pressure regulator 200 that uses flowing orifice damping. A fluid with a pressure to be regulated is provided at an input 205 of a valve 210. A spring 220 urges the valve 210 toward a position that restricts or blocks fluid flow between the inlet 205 and the outlet 215.

A control fluid is provided as a reference pressure at an input 230. The control fluid flows from the input 230 to an input flowing orifice 240 and an output flowing orifice 250 connected in series with the input orifice 240. A differential pressure is developed in a fluid pathway 260 that fluidically connects the input flowing orifice 240 and the output flowing orifice 250.

The valve 210 is responsive to changes in flow through it. In general, as the flow at inlet 205 decreases pressure within the fluid pathway 260 is added to the bias force of the spring 220 to urge the valve 210 toward a position that restricts fluid flow between the inlet 205 and the outlet 215. Reducing the allowable flow area as flow level decreases maintains the inlet 205 pressure level. The inlet 205 pressure level remains at an approximately fixed level above the pathway 260 value even though flow through the valve varies.

Flowing orifice damping, as implemented in the pressure regulator 200, is substantially temperature insensitive (e.g., good) and tends to be proportional to the velocity of the valve 210 (e.g., good) rather than to the square of valve velocity. As such, the flowing orifices 240 and 250 provide damping at both low and high valve velocities, and the damping is less amplitude dependent as compared to the non-flowing orifice 140. Flowing orifice embodiments, however, result in internal leakage that can have adverse performance impacts on upstream and/or downstream systems.

FIG. 3 is a schematic diagram of an example fluid pressure regulator 300 that implements orifice damping with switching. In general, the pressure regulator 300 implements a flowing orifice design while eliminating the adverse consequence of internal leakage. In some implementations, the pressure regulator 300 may be a component within a system for regulating fuel flow to an aircraft engine.

A fluid with a pressure to be regulated is provided at an input 305 of a valve 310. A spring 320 urges the valve 310 toward a position that restricts or blocks fluid flow between the inlet 305 and the outlet 315.

The valve 310 is responsive to changes in flow through it. In general, as flow at inlet 305 decreases the pressure within fluid pathway 360 is added to the bias force of the spring 320 to urge the valve 310 toward a position that restricts fluid flow between the inlet 305 and the outlet 315. Reducing the allowable flow area as flow level decreases maintains the inlet 305 pressure level. The inlet 305 pressure level remains at an approximately fixed level above the pathway 360 value even though flow through the valve varies A control fluid is provided at a reference pressure to an adjustment input 330. The control fluid flows from the adjustment input 330 to a bypass valve 370 which is biased by a spring 380. When the bypass valve 370 is open, the control fluid is allowed to flow to an input flowing orifice 340 and an output flowing orifice 350 connected in series with the input orifice 340. A differential pressure is developed in a fluid pathway 360 that fluidically connects the input flowing orifice 340 and the output flowing orifice 350. When the bypass valve 370 is closed, the control fluid is blocked from flowing to the input flowing orifice 340.

The flowing damping orifice configuration of the valve 310 provides dynamic benefits, however in some implementations the leakage flow consumed by the combination of the input flowing orifice 340 and the output flowing orifice 350 may not always be beneficial, e.g., at engine start in engine fuel pressure regulator applications. In engine fuel pressure control implementations, at engine start speed, engine speed is low, which can result in low pump flow. The bypass valve 370 can be responsive to this low pump flow, and can position itself near a closed stop, blocking flow to the input flowing orifice. As engine speed increases, so too does pump flow, which can reposition the bypass valve 370 to a more open position that permits excess pump fluid flow through the bypass valve 370.

The bypass valve 370 is responsive to an external signal. In some embodiments, the external signal can be the pressure of the end chambers 390 and 392. For example, the bypass valve 370 may by urged closed by the spring 380 and pressure within an end chamber 390, and may remain closed until the pressure of an end chamber 392 is sufficient to overcome the bias of the spring 380 and pressure within the end chamber 390. In some embodiments, the external signal can be an electrical signal. For example, the valve 370 can be an electromechanical valve that is operable to selectively block or allow flow of the control fluid between the adjustment input 330 and the input flowing orifice 340 in response to an electrical signal. In some embodiments, the external signal can be a fluid signal. For example, the valve 370 can be an fluidically actuated valve that is operable to selectively block or allow flow of the control fluid between the adjustment input 330 and the input flowing orifice 340 in response to a fluid (e.g., hydraulic, pneumatic) signal that is separate from the control fluid.

In aircraft applications, space and weight can be limited commodities. Use of the pressure regulator 100 of FIG. 1 in such examples may allow high-frequency pressure oscillations in the fuel to go substantially undamped across the valve 110. For example, the operation of fuel injectors downstream of the pressure regulator 100 may introduce oscillations that can back-propagate and cause problems with equipment upstream from the pressure regulator 100 (e.g., noisy sensor readings, damage to fuel pumps). In another example, oscillations introduced upstream of the pressure regulator 100 (e.g., by fuel pumps, vibration from the engine) can propagate to and interfere with the function of equipment downstream from the pressure regulator (e.g., fuel injectors).

Use of the pressure regulator 200 of FIG. 2 in such examples (e.g., aircraft engine systems) may increase the total weight of the engine system. For example, the flow of control fluid through the fluid pathway 260 may be dependent upon engine speed, such as by an engine-driven pump, and the input flowing orifice 240 and the output flowing orifice 250 may be selected to provide a desired pressure within the fluid pathway 260 at normal engine operating speeds. At idle engine speeds however, the flow provided through the fluid pathway 260 by such an engine speed-dependent pump can drop far enough to prevent the valve 210 from functioning as needed. This situation can be resolved by using a larger pump that is capable of providing sufficient flow at idle speeds, however such larger pumps are generally correspondingly larger, heavier, and/or more costly than pumps that can provide sufficient flow at normal engine speeds.

By contrast, the pressure regulator 300 of FIG. 3 avoids the need for larger pumps. At normal engine speeds, the valve 310 operates much like the valve 210, and the pump used to supply control fluid to the adjustment input 330 can be sized to provide the desired flow at normal engine speeds. But unlike the pressure regulator 200, the pressure regulator 300 includes the bypass valve 370 that can be activated at low engine speeds

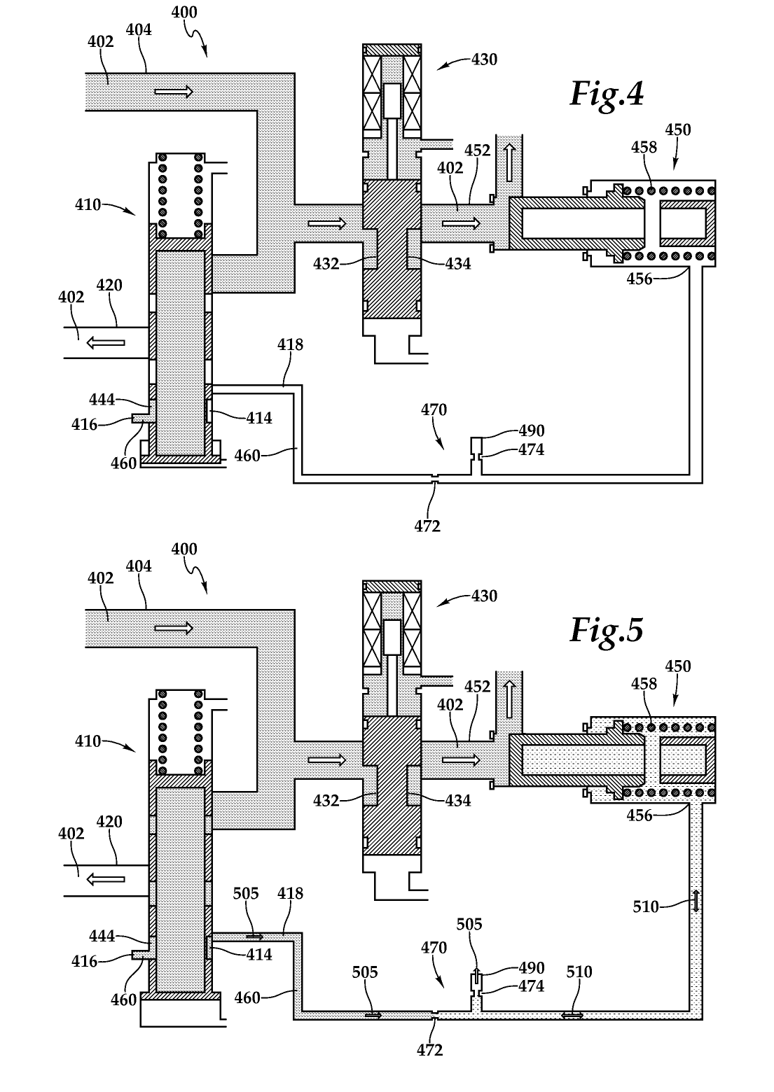

FIGS. 4 and 5 are schematic diagrams of an example fluid delivery system 400 that includes an example fluid pressure regulator with damping. The system 400 includes a bypass valve 410, a metering valve 430, and a pressurizing valve 450 (e.g., pressure regulator). In some implementations, the system 400 can regulate fuel flow to an aircraft engine.

In general, a fluid 402 (e.g., fuel) is provided at a fluid inlet 404. The fluid flows to a meter inlet 432 of the metering valve 430, and out a meter outlet 434 to a pressurizing valve inlet 452 of the pressurizing valve 450. The pressurizing valve 450 regulates the pressure of the fluid 402 at an outlet 452 in response to the pressure of a fluid 460 applied at an input 456.

In use, the bypass valve 410 maintains a substantially constant differential pressure across the metering window of the metering valve 430. The metering valve 430 holds a metering port window that corresponds to the desired flow of the fluid 402 at the outlet 452 (e.g., a desired engine burn flow). The pressurizing valve 450 maintains at least a predetermined minimum fluidic pressure used to provide fluidic force margins for the metering valve 430 and internal or external actuation systems.

The bypass valve 410 includes a pressure switch 414 affixed to the bypass valve. The pressure switch 414 controls the flow of the fluid 460 from a switch inlet 416 to a switch outlet 418, and on to a flowing damping orifice assembly 470 which includes a flowing inlet orifice 472 and a flowing outlet orifice 474. The flowing damping orifice assembly 470 restricts the flow of the fluid 460 and dampens the response of the pressurizing valve 450. In some embodiments, the flowing inlet orifice 472 can be the input flowing orifice 340 of FIG. 3, the flowing outlet orifice 474 can be the output flowing orifice 350, and the fluid 460 can be the fluid 360.

In some implementations, the configuration shown in FIG. 4 may be used in an engine fuel delivery application. Referring to FIG. 4, the bypass valve 410 is in a near closed position during engine start conditions. The pressure of the fluid 460 at the switch inlet 416 is isolated from the flowing damping orifice assembly 470, resulting in no added fluid flow to support the damping arrangement. In this configuration, the pressure of the fluid 460 provided to the pressurizing valve 450 is the same as the pressure of the fluid 460 at an outlet 490. Pressure at the outlet 490 approximates the pressure of the fluid 402 at a bypass valve outlet 420 of the bypass valve 410. The setting of pressure level 452 is a function of preload provided by a spring 458 and pressure at the outlet 490.

In the example configuration of FIG. 4, bypass valve 410 and setting of the pressure switch 414 reduces or eliminated system leakage through the flowing damping orifice assembly 470. In some implementations, the illustrated configuration can reduce pump flow demand at engine start conditions.

Referring now to FIG. 5, the bypass valve 410 is shown in an open configuration. In some implementations, the example configuration of the system 400 may be used at idle engine speeds or higher. The fluid 460 is connected to the flowing damping orifice assembly 470. The fluid 460 flows from the flowing inlet orifice 472 to the flowing outlet orifice 474 as a circuit flow 505. The circuit flow 505 from the flowing inlet orifice 472 to the flowing outlet orifice 474 creates a differential fluid pressure 510 that is provided at the adjustment input 456. The circuit flow 505 is supplied by pump flow to support the damping arrangement provided by the flowing damping orifice assembly 470. In some implementations, aircraft engine systems have excess pump flow at idle engine speeds and above, which provide flow that meet or exceed the circuit flow 505.

In the present example, the pressure of the fluid 460 at the switch inlet 416 can be about 150 to 400 psid above the fluid pressure 510. The setting of the pressurizing valve 450 is a function of preload of the spring 458 plus the fluid pressure 510 setting. In some embodiments, having a relatively high differential pressure between the fluid 402 at the inlet 404 and at the outlet 420 can be used in high actuation system pressure applications to reduce the size requirement for internal and external actuators.

In some embodiments, the position of the switch 414 may be variable between its fully open and fully closed configurations. For example, the position of the bypass valve 410 at aircraft takeoff conditions can be similar to the position of the bypass valve 410 at aircraft engine start conditions, e.g., both conditions can result in positions of the bypass valve 410 near the full closed position. In some embodiments, analysis can be used during aircraft takeoff to determine that system pressure (e.g., the differential pressure between the fluid 402 at the fluid inlet 404 and at the bypass valve outlet 420) may be set via nozzle and/or compressor discharge pressure drops, and the pressurizing valve 450 can be fully open, in which case there may be no need for the flowing damping orifice assembly 470, and closure of the switch 414 may be redundant.

In some embodiments, the fluid 460 pressure can be equivalent to fluid pressure at the inlet 404. In some embodiments, the fluid 460 can be replaced by a fluid (e.g., the fluid 402 at the inlet 404) that has passed through heaters and/or screens. The pressure of the heated and/or screened fluid can be nearly equivalent to the pressure of the fluid 402. In still other embodiments, the fluid 460 can be replaced by a fluid that is supplied by an alternate pressure regulator having a pressure setting less than the pressure of the fluid at the inlet 404.

Although a few implementations have been described in detail above, other modifications are possible. For example, logic flows do not require the particular order described, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A fuel pressure regulator system for regulating pressure through a fuel delivery path, comprising:
a fuel pressure regulator valve in the fuel delivery path operable to selectively provide a restriction in the fuel delivery path in response to a reference fluid pressure;
a reference fluid path comprising a first orifice, a second orifice and an outlet downstream of the first orifice, the reference fluid path coupled to the fuel pressure regulator valve intermediate the first and second orifices to supply the reference fluid pressure to the fuel pressure regulator valve; and
a reference fluid valve upstream of the first orifice operable to selectively provide a restriction into the reference fluid path.

2. The fuel pressure regulator system of claim 1, wherein the reference fluid valve is operable in response to a control signal.

3. The fuel pressure regulator system of claim 2, wherein the control signal is indicative of a threshold speed of an engine, and the reference fluid valve is operable to provide the restriction into the reference fluid path when the control signal indicates that the engine is operating below the threshold speed and remove the restriction into the reference fluid path when the control signal indicates that the engine is operating at or above the threshold speed.

4. The fuel pressure regulator system of claim 1, wherein the reference fluid valve is operable in response to the reference fluid pressure, the reference fluid valve providing the restriction into the reference fluid path when the reference fluid pressure is below a threshold pressure and removing the restriction into the reference fluid path when the reference fluid pressure is at or above the threshold pressure.

5. The fuel pressure regulator system of claim 4, wherein the reference fluid pressure is indicative of an operating speed of an engine, and the threshold pressure is reflective of the threshold operating speed of the engine.

6. A method for regulating fuel pressure through a fuel delivery path comprising:
providing a fuel pressure regulator valve in the fuel delivery path operable to selectively provide a restriction between a fuel inlet and a fuel outlet in the fuel delivery path in response to a reference fluid pressure;
providing a reference fluid path comprising a first orifice, a second orifice and an outlet downstream of the first orifice, the reference fluid path coupled to the fuel pressure regulator valve intermediate the first and second orifices to supply the reference fluid pressure to the fuel pressure regulator valve;
providing a reference fluid valve upstream of the first orifice operable to selectively provide a restriction into the reference fluid path;
providing a reference fluid at the reference fluid valve;
providing a first control signal at the reference fluid valve;
restricting, by the reference fluid valve in response to the first control signal, flow of the reference fluid;
providing the reference fluid and a second control signal at the reference fluid valve;
flowing, by the reference fluid valve in response to the second control signal, the reference fluid to the first orifice;
restricting, by the first orifice, flow of the reference fluid to the reference fluid path;
restricting, by the second orifice, flow of the reference fluid out of the reference fluid path, wherein flow of the reference fluid into the reference fluid path and flow of the reference fluid out of the reference fluid path create the reference fluid pressure as a differential pressure in the reference fluid path;
providing fuel to the fuel pressure regulator valve at the fuel inlet; and
selectively providing, by the fuel pressure regulator valve and in proportion to the reference fluid pressure, the restriction between the fuel inlet and the fuel outlet in the fuel delivery path in response to the reference fluid pressure.

7. The method of claim 6, wherein the first control signal is indicative of an engine running below a threshold speed, and the second control signal is indicative of the engine running at or above a threshold speed.

8. The method of claim 7, wherein the first control signal is a first pressure of the reference fluid, and the second control signal is a second pressure of the reference fluid.

9. The method of claim 7, wherein at least one of the first control signal and the second control signal is an electrical command from the engine.
